(19) United States
(12) Patent Application Publication
(10) Pub. No.: US 2008/0152177 A1
(43) Pub. Date: Jun. 26, 2008

(54) BEHIND-THE-EAR HEARING AID

(75) Inventors: Keisuke WATANUKI, TOKYO (JP); Takashi YAMASAKI, TOKYO (JP)

Correspondence Address: LEE FREDRIC SHARRA, 4313 TROUTHAVEN DRIVE, MURRYSVILLE, PA, 15668, US

(73) Assignee: RION CO., LTD., TOKYO (JP)

(21) Appl. No.: 11/962,265

(22) Filed: Dec. 21, 2007

(30) Foreign Application Priority Data
Dec. 26, 2006 (JP) JP 2006-349207

(51) Int. Cl. H04R 25/00; H04R 25/02

(52) U.S. Cl. 381/330

(57) ABSTRACT

In a behind-the-ear hearing aid 1 having a hook 3, a tube 4 and a joint 5 between a hearing aid body 2 and an ear-plug 6, the joint 5 is provided with a damper 8. It is desirable that the value of the acoustic impedance of the damper 8 be less than ±10% of the value of the characteristic impedance of a path 7 formed by making connections between the hook 3, the tube 4 and the joint 5.

### BACKGROUND OF THE INVENTION

1. Field of the Invention

The present invention relates to a behind-the-ear hearing aid which is provided with a hook, a tube and a joint between a hearing aid body and an ear-plug.

2. Description of the Prior Art

A sound produced from an earphone of a behind-the-ear hearing aid is transmitted to an external auditory meatus through a hook, a tube, a joint and an ear-plug. At this time, it is known that, as a result of a reflected wave caused by the mismatching of the characteristic impedance of a path formed by making connections between the hook, the tube and the joint and beyond an end of the path, a standing wave is produced in a specific frequency within the path to provide a frequency characteristic (hereinafter referred to as a “path frequency characteristic”). If there is a peak in the path frequency characteristic, there are some cases where howling (an acoustic feedback) is caused. A damper is used to control the peak generated in such a frequency characteristic. It is generally known that the damper is disposed in the hook (for example, refer to Patent Document 1).

Patent Document 1: Japanese Patent Application Publication No. S62-151100

However, if there is a distance between the damper and an opening section of an ear-plug end section adapted to emit a sound to an external auditory meatus, there is some possibility that it may not be possible to effectively control the peak generated in a frequency characteristic of the path formed by making connections between the hook, the tube and the joint. In this case, a peak may be newly generated in another frequency.

### SUMMARY OF THE INVENTION

It is therefore an object of the present invention to solve the problems as seen in the prior art and to provide an improved behind-the-air hearing aid which can control a peak generated in a frequency characteristic of a path formed by making connections between a hook, a tube and a joint.

In order to attain this object, according to a first aspect of the present invention, a behind-the-ear hearing aid having a hook, a tube and a joint between a hearing aid body and an ear-plug is provided, in which the joint is provided with a damper.

According to a second aspect of the present invention, the behind-the-ear hearing aid according to the first aspect is provided, in which the value of the acoustic impedance of the damper is less than ±10% of the value of the characteristic impedance of a path formed by making connections between the hook, the tube and the joint.

### BRIEF DESCRIPTION OF THE DRAWINGS

The above and other objects, features and advantages of the present invention will become more apparent from the following description when taken in conjunction with the accompanying drawings.

FIG. 1 is a schematic perspective view of a behind-the-ear hearing aid according to the present invention;

FIG. 2 is a cross-sectional view of a joint and the like; and

FIG. 3 is an explanatory view of a damper, wherein FIG. 3(a) is a plan view of the damper and FIG. 3(b) is a cross-sectional view taken along line A-A of FIG. 3(a).

### DETAILED DESCRIPTION OF THE PREFERRED EMBODIMENTS

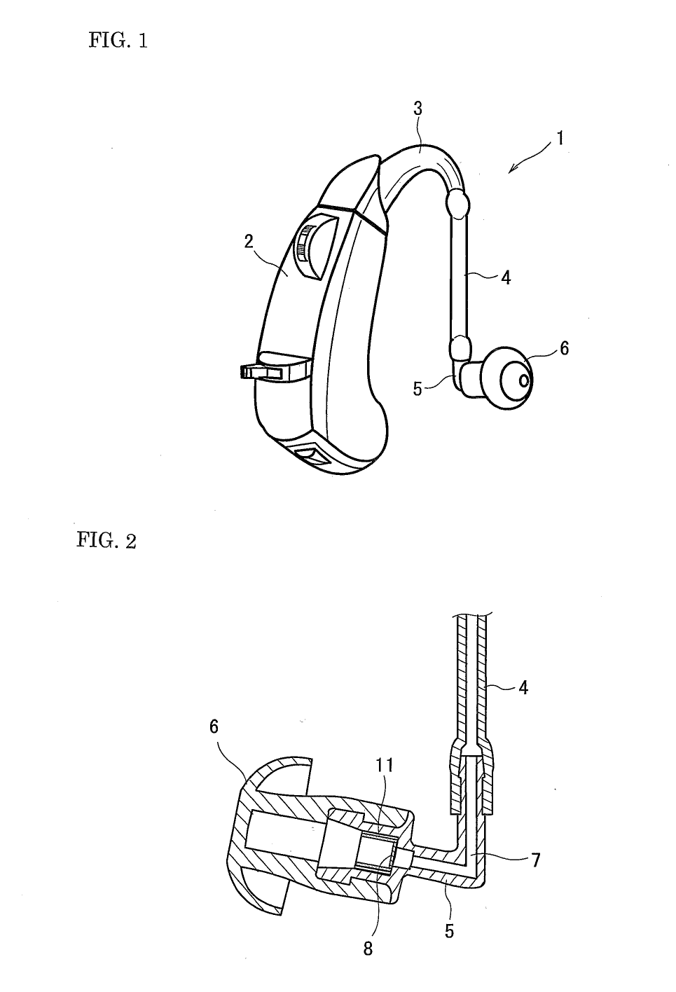

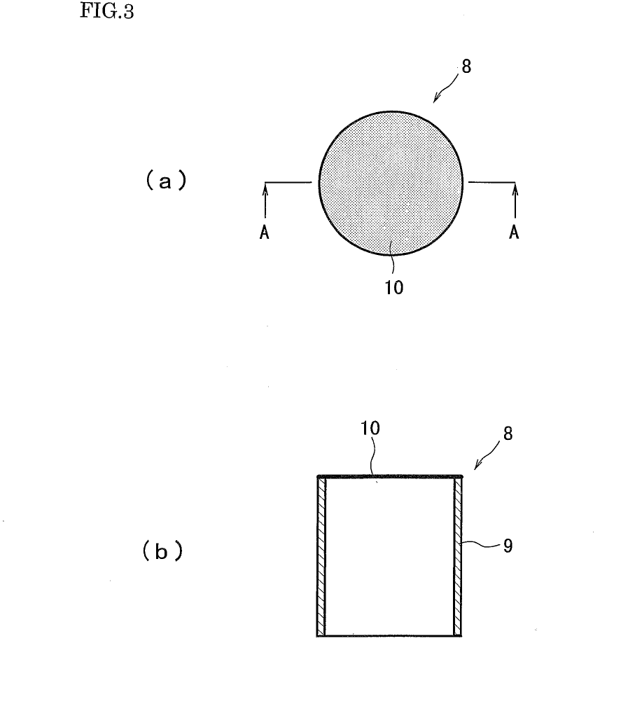

A preferred embodiment of the present invention will now be described with reference to the accompanying drawings. FIG. 1 is a schematic perspective view of a behind-the-air hearing aid according to the present invention. FIG. 2 is a cross-sectional view of a joint and the like. FIG. 3 is an explanatory view of a damper.

A behind-the-air hearing aid 1 according to the present invention includes, as shown in FIG. 1, a hearing aid body 2, a hook 3, a tube 4, a joint 5, and an ear-plug 6. The hook 3, the tube 4 and the joint 5 are connected in series to form a path 7 (tube) through which a sound emitted from an earphone is passed. The hearing aid body 2 houses a hearing processing section, a microphone, an earphone and the like which are not shown in the figure.

As shown in FIG. 2, a damper 8 serving as an acoustic filter is fitted into the joint 5. The damper 8 is provided, as shown in FIG. 3, with a membrane 10 of a mesh shape on one opening section of a cylinder body 9. The damper 8 brings the cylinder body 9 into close contact with an inner wall surface of the joint 5 through a sealing member 11 to form part of the path 7 through which a sound emitted from the earphone is passed.

The value of an acoustic impedance of the damper 8 is set to be less than ±10% of the value of a characteristic impedance of the path 7 formed by making connections between the hook 3, the tube 4 and the joint 5. For example, if the value of the characteristic impedance of the path 7 formed by making connections between the hook 3, the tube 4 and the joint 5 is 2100Ω, the damper 8 of which the value of the acoustic impedance is 2200Ω is fitted into the joint 5. In this case, the ear-plug 6 of an existing type can be used.

Operation of the behind-the-ear hearing aid according to the present invention as constructed above will now be described. A sound processed by the hearing aid body 2 to be emitted from the earphone is transmitted to an external auditory meatus from the ear-plug 6 through the path 7 formed by making connections between the hook 3, the tube 4 and the joint 5. In this case, since the value of the acoustic impedance of the damper 8 substantially corresponds to that of the characteristic impedance of the path 7 formed by making connections between the hook 3, the tube 4 and the joint 5, it is difficult for reflection to be caused. Thus, it is possible to control a peak generated in the frequency characteristic of the path 7 and howling can be reduced.

### Effects of the Invention

According to the first aspect of the present invention, it is possible to effectively control a peak generated in frequency characteristics of a path formed by making connections between a hook, a tube and a joint. In this case, an existing ear-plug can also be used.

According to the second aspect of the present invention, by causing the value of the acoustic impedance of a damper to substantially correspond to the value of the characteristic impedance of the path formed by making connections between the hook, the tube and the joint, it is difficult for reflection to be generated. It is therefore possible to effectively control the peak generated in the frequency characteristic.

### INDUSTRIAL APPLICABILITY

By simply providing a joint with a damper, it is possible to effectively control a peak generated in the frequency characteristic of a path formed by making connections between a hook, a tube and a joint and as a result, a behind-the-ear hearing aid, which creates a good feeling when worn, can be readily provided.

What is claimed is:

1. A behind-the-ear hearing aid having a hook, a tube and a joint between a hearing aid body and an ear-plug, wherein the joint is provided with a damper.

2. The behind-the-ear hearing aid according to claim 1, wherein the value of the acoustic impedance of the damper is less than ±10% of the value of the characteristic impedance of a path formed by making connections between the hook, the tube and the joint.
